(19) United States
(12) Patent Application Publication
(10) Pub. No.: US 2026/0004108 A1
(43) Pub. Date: Jan. 1, 2026

(54) ACCIDENT SEQUENCE SCREENING METHOD BASED ON COMBINATION OF FCNN AND PSO

(71) Applicant: HARBIN ENGINEERING UNIVERSITY, Harbin (CN)

(72) Inventor: Lei LI, Harbin (CN)

(21) Appl. No.: 18/861,175

(22) PCT Filed: Apr. 13, 2023
(86) PCT No.: PCT/CN2023/088074

§ 371 Date: Aug. 11, 2025

(30) Foreign Application Priority Data
Apr. 29, 2022 (CN) 202210473115.7

(51) Int. Cl. G06N 3/047

(52) U.S. Cl. CPC G06N 3/047

(57) ABSTRACT

Provided is an accident sequence screening method based on a combination of a fully connected neural network (FCNN) and particle swarm optimization (PSO), relating to the technical field of accident sequence screening, comprising the following steps: S101, defining a research object and a target parameter, and completing deterministic and probabilistic modeling; S201, concurrently computing RELAP5 programs by using a concurrent computing method, to quickly construct a deep learning database; S301: constructing a deep learning surrogate model by using an FNCC analysis method, to replace RELAP5 for accident analysis; and S401: calling the deep learning surrogate model for accident analysis by using a PSO approach, quickly capturing an optimal solution for each accident sequence, and screening out sequences that require Best Estimate Plus Uncertainty (BEPU) analysis. In this method, a surrogate model is constructed based on a fully connected neural network to replace a conventional system simulation program, which improves the efficiency of single accident analysis; optimization calculations are performed for the constructed surrogate model by using a PSO algorithm, which reduces the amount of analysis calculations.

### CROSS REFERENCE TO RELATED APPLICATION

This patent application is a national stage application of International Patent Application No. PCT/CN2023/088074, filed on Apr. 13, 2023, which claims the benefit and priority of Chinese Patent Application No. 202210473115.7, filed with the China National Intellectual Property Administration on Apr. 29, 2022, the disclosure of which is incorporated by reference herein in its entirety as part of the present application.

### TECHNICAL FIELD

The present disclosure relates to the technical field of accident sequence screening, and in particular, to an accident sequence screening method based on a combination of a fully connected neural network (FCNN) and particle swarm optimization (PSO).

### BACKGROUND

The traditional safety evaluation methods for nuclear power plants include Deterministic Safety Analysis (DSA) and Probabilistic Safety Analysis (PSA). However, both methods have certain limitations: DSA methods only focus on specific sequences of representative design basis accidents with extremely low probabilities, leading to overly conservative decision criteria. In PSA methods, the stochastic uncertainty in the accident process well can be taken into consideration, but calculation assumptions for success criteria are simplified and conservative, resulting in poor capability to handle minor operational changes in nuclear power plants. Therefore, the Risk-Informed Safety Margin Characterization (RISMC) method based on DSA and PSA has become a research hotspot.

The existing RISMC method models all accident sequences using the PSA analysis method, and then analyzes each accident sequence using a Best Estimate Plus Uncertainty (BEPU) analysis method to obtain a final target parameter distribution, thereby determining the safety performance of the nuclear power plant. FIG. 1 illustrates an analysis process of the RISMC method for small-break loss-of-coolant accidents in nuclear power plants. In order to measure the integrity of the reactor core, the peak cladding temperature (PCT) is used as the target parameter.

Taking the best estimate program RELAP5 as an example, using a computer with an i7-9700K 3.6 GHz CPU for 5000 s of simulation calculation takes about 6 minutes. In order to ensure the reliability of the uncertainty analysis results, nearly a thousand sets of calculations are required for a single sequence using random sampling. Serial calculation analysis for a single sequence takes about 100 hours. When there are a large number of accident sequences, the computational workload becomes excessive.

Therefore, it is an urgent issue for technical personnel in this field to propose an accident sequence screening method based on a combination of an FCNN and PSO to improve the efficiency of single accident analysis and reduce the computational workload.

### SUMMARY

Accordingly, the present disclosure provides an accident sequence screening method based on a combination of an FCNN and PSO, which effectively improves the efficiency of single accident analysis and reduces the computational workload.

To achieve the above objective, the present disclosure adopts the following technical solutions:

The accident sequence screening method based on a combination of an FCNN and PSO includes the following steps:
S101: defining a research object and a target parameter, and completing deterministic and probabilistic modeling;
S201: concurrently computing RELAP5 programs by using a concurrent computing method, to quickly construct a deep learning database;
S301: constructing a deep learning surrogate model by using an FCNN analysis method, to replace RELAP5 for accident analysis; and
S401: calling the deep learning surrogate model for accident analysis by using a PSO approach, quickly capturing an optimal solution for each accident sequence, and screening out sequences that require BEPU analysis.

Optionally, S101 specifically includes the following steps:
S1011: modeling the research object based on deterministic analysis;
S1012: determining all accident sequences based on a probabilistic model;
S1013: determining uncertainty parameters, distributions of the uncertainty parameters, and the target parameter; and
S1014: performing parameter sensitivity analysis to select key parameters.

Optionally, S1011 of modeling the research object based on deterministic analysis specifically includes the following steps:
S10111: determining an object and an accident to be analyzed;
S10112: obtaining all necessary parameter information for a modeling process;
S10113: completing an object node diagram based on the key parameters, and writing input cards; and
S10114: after modeling is completed, comparing simulation results with design parameters to ensure that modeling accuracy meets analysis requirements.

Optionally, S201 specifically includes the following steps:
S2011: performing initialization for concurrent computing, where input parameters, ranges and distributions of the input parameters, and the target parameter need to be initialized before concurrent computing; and defining inputs and outputs for database construction;
S2012: testing performance of computer equipment and completing initialization settings of an optimization program;
S2013: updating RELAP5 input files in batches by using multiple threads;
S2014: performing multi-threaded RELAP5 calculations; and
S2015: constructing input and output databases.

Optionally, S301 specifically includes the following steps:
S3011: constructing an FCNN deep learning surrogate model; and
S3012: determining whether an FCNN deep learning surrogate model generated when a current database sample size remains unchanged meets accuracy requirements; if yes, completing model construction and proceeding to S401 after encapsulation, to participate in concurrent computing; otherwise, returning to S201 to increase the number of learning database samples.

Optionally, S3011 of constructing the FCNN deep learning surrogate model specifically includes the following steps:
S30111: calling a learning database, and importing generated database samples to this step for model construction;
S30112: initializing input layer learning sample data and test sample data: updating nominal values of an input layer and an output layer of an FCNN based on input parameters and output parameters in the database; and initializing activation functions and key information of the FCNN;
S30113: hidden layer fitting, where data from the input layer undergoes nonlinear fitting through an activation function in a hidden layer, and when there are a plurality of hidden layers, an output of a previous hidden layer is passed as an input to a next hidden layer;
S30114: data output by the output layer, where an initial parameter from the input layer yields a fitted target parameter after hidden layer fitting;
S30115: determining whether an error of fitted output data with respect to a nominal value meets requirements: comparing the fitted target parameter from the output layer with a standard target parameter calculated by the RELAP5 program in the database, and if the error meets a specified value, proceeding to S30116; if the error does not meet the specified value, performing automatic parameter adjustment using an Adam algorithm, proceeding to S30113 until the specified value is met, and then proceeding to S30116; and
S30116: determining whether accuracy of test samples meets specified requirements: importing input data of the test samples into the model and comparing resulting output values with standard output values in the test samples; if the requirements are met, proceeding to a next step; otherwise, continuing with parameter adjustment using the Adam algorithm, until the accuracy meets the specified requirements.

Optionally, S401 specifically includes the following steps:
S4011: performing calculations on nominal input values of all accident sequences in S101 using the RELAP5 programs to obtain a nominal target parameter for each sequence;
S4012: classifying the accident sequences and determining target parameter calculation demand of the accident sequences; and
S4013: calculating optimal solutions for the accident sequences using a PSO algorithm.

Optionally, S4013 of calculating the optimal solutions for the accident sequences using the PSO algorithm specifically includes the following steps:
S40131: initializing particle parameters: setting the number of particles per generation, particle dimensions, total iterations, an inertia weight factor, a learning factor, and key parameters according to the computational requirements, to control a scale and efficiency of PSO optimization;
S40132: determining input parameters and a target parameter, and completing program initialization settings: updating input parameter information and target parameter information based on a sensitivity analysis result in S101, and performing initialization;
S40133: calling the deep learning surrogate model and performing concurrent computing: calling the deep learning surrogate model encapsulated in S301 to replace RELAP5 for accident analysis calculations;
S40134: obtaining the target parameter and updating best fitness values: outputting the target parameter calculated by the deep learning surrogate model, comparing and updating optimal solutions for each generation of the target parameter;
S40135: determining whether a convergence condition is met: when any convergence condition is met, completing program calculations and proceeding to S40136; otherwise, updating initial parameters of each accident analysis sequence based on the PSO algorithm and proceeding to S40133 for iterative calculations;
S40136: outputting optimal solution data; and
S40137: outputting a sequence screening result: based on a comparison of the optimal solution data with safety limits and analysis in S40135, outputting serial numbers of accident sequences that require BEPU analysis.

Optionally, the convergence condition for PSO calculations includes: (1) a maximum number of iterations is reached; (2) in consecutive generations, changes in optimal solutions are within an error range; (3) an outlier occurs in the target parameter, where the outlier means that a relationship between a calculated target parameter of a sequence and the safety limits is different from a relationship between the nominal target parameter of the sequence and the safety limits.

From the above technical solution, it is evident that compared to the existing technology, the present disclosure provides an accident sequence screening method based on a combination of an FCNN and PSO, which includes: performing concurrent calculations on RELAP5 to quickly construct a deep learning database; based on FCNN, constructing a deep learning surrogate model with sufficient accuracy to replace RELAP5 for accident analysis, thereby improving the computing efficiency of individual accident analysis cases and the program stability when calling PSO analysis. The PSO approach rapidly captures optimal solutions for the target parameter of the accident sequences, and completes the accident sequence screening, thereby reducing the number of sequences requiring BEPU analysis.

### BRIEF DESCRIPTION OF THE DRAWINGS

To describe the technical solutions in the embodiments of the present disclosure or in the prior art more clearly, the drawings required for describing the embodiments or the prior art will be briefly described below. Apparently, the drawings in the following description merely show the embodiments of the present disclosure, and those of ordinary skill in the art can still derive other drawings from the provided drawings without creative efforts.

FIG. 1 illustrates an analysis process of a RISMC method for small-break loss-of-coolant accidents in nuclear power plants;

FIG. 2 is a flowchart of an accident sequence screening method based on a combination of an FCNN and PSO according to the present disclosure;

FIG. 3 is a detailed flowchart of an accident sequence screening method based on a combination of an FCNN and PSO according to the present disclosure;

FIG. 4 is a flowchart of concurrent calculations for quickly constructing a deep learning database according to the present disclosure;

FIG. 5 is a principle diagram of an FCNN;

FIG. 6 is a flowchart of constructing an FCNN deep learning surrogate model according to the present disclosure;

FIG. 7 is a flowchart of calculating optimal solutions for accident sequences using a PSO approach according to the present disclosure; and

FIG. 8 is a principle diagram of data iterations in a PSO algorithm according to the present disclosure.

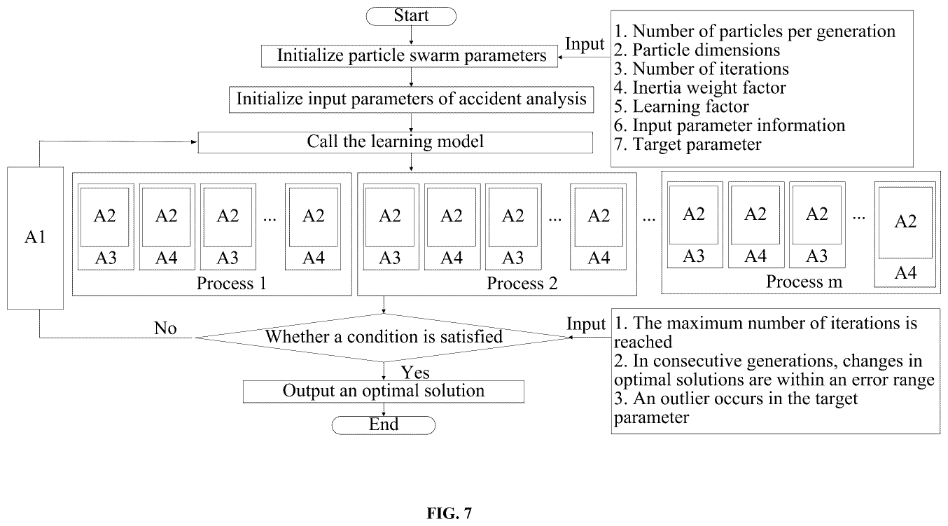

Reference numerals in FIG. 7:
A1: Update the input parameters based on the PSO algorithm
A2: Surrogate model computing, and data processing
A3: Thread 1
A4: Thread 2

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

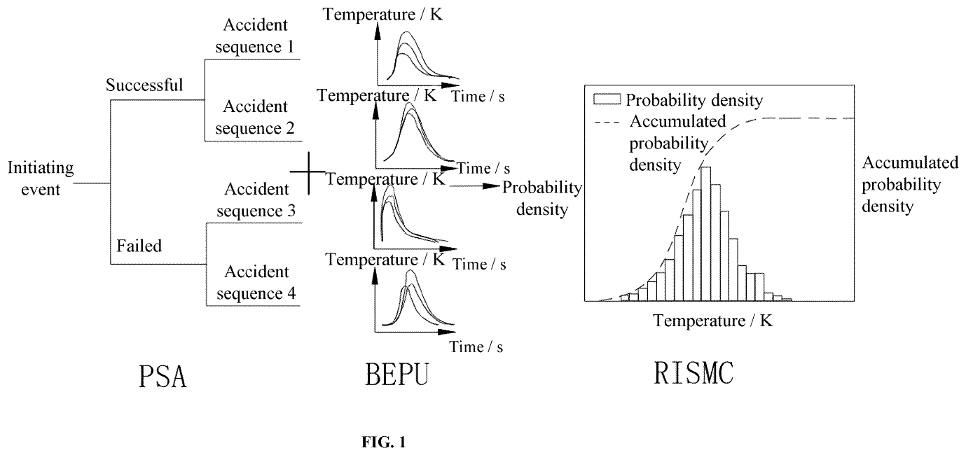

FIG. 1 illustrates an analysis process of an RISMC method for small-break loss-of-coolant accidents in nuclear power plants. In order to measure the integrity of the reactor core, the peak cladding temperature (PCT) is used as the target parameter. Taking the best estimate program RELAP5 as an example, using a computer with an i7-9700K 3.6 GHz CPU for 5000 s of simulation calculation takes about 6 minutes. In order to ensure the reliability of the uncertainty analysis results, nearly a thousand sets of calculations are required for a single sequence using random sampling. Serial calculation analysis for a single sequence takes about 100 hours. When there are a large number of accident sequences, the computational workload becomes excessive.

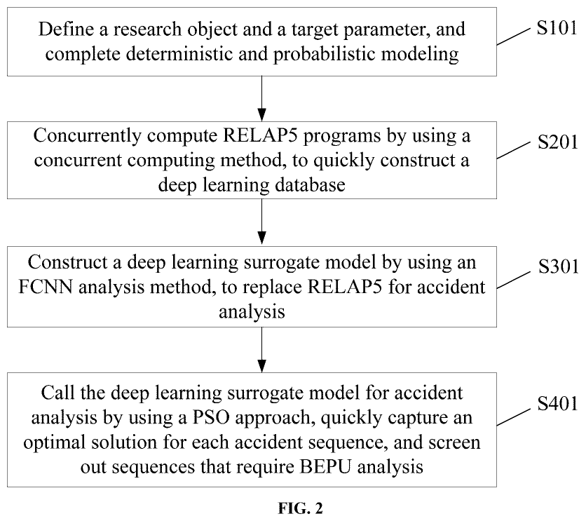

Based on this, the present disclosure proposes a method for screening nuclear reactor accident sequences based on a combination of a fully connected neural network and particle swarm optimization (FCNN-PSO), as shown in FIG. 2.

To address the issue of low efficiency of single accident analysis, this method construct a surrogate model to replace RELAP5 for accident calculations. The FCNN approach is as an effective approach for building the surrogate model due to its ease of implementation and strong nonlinear fitting capability. By concurrently computing RELAP5 programs, a deep learning database is rapidly trained. The FCNN approach is then used to construct a surrogate model based on this database, to replace the RELAP5 program for accident analysis, thereby reducing the time for a single analysis from minutes to seconds, and effectively improving the efficiency of single accident analysis. During BEPU analysis for all accident sequences, to address the issue of high computational workload for cases, the method uses an optimization algorithm to rapidly capture an optimal solution for each accident sequence, and classifies the accident sequences to select sequences that require BEPU analysis. The PSO approach is chosen as the optimization algorithm for screening due to its ease of implementation, high accuracy, fast convergence, and suitability for parallel computing.

As shown in FIG. 2, the present disclosure provides an accident sequence screening method based on a combination of an FCNN and PSO, including the following steps:
S101: Define a research object and a target parameter, and complete deterministic and probabilistic modeling.
S201: Concurrently compute RELAP5 programs by using a concurrent computing method, to quickly construct a deep learning database.
S301: Construct a deep learning surrogate model by using an FCNN analysis method, to replace RELAP5 for accident analysis.
S401: Call the deep learning surrogate model for accident analysis by using a PSO approach, quickly capture an optimal solution for each accident sequence, and screen out sequences that require BEPU analysis.

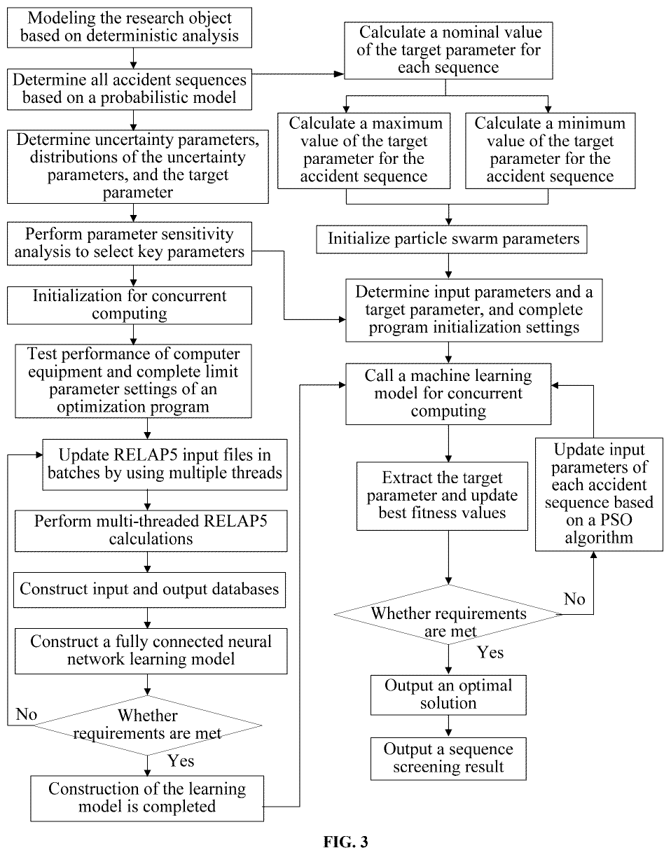

FIG. 3 is a detailed flowchart of an accident sequence screening method based on a combination of an FCNN and PSO.

Furthermore, S101 specifically includes the following steps:
S1011: Model the research object based on deterministic analysis.
S1012: Determine all accident sequences based on a probabilistic model.

Based on a power plant and accident information that have been defined in the process of deterministic modeling, an event tree model with corresponding accuracy is established, and each accident sequence is outlined. The finer the deterministic modeling, involving more systems and equipment, the more complex the event tree becomes. The event tree model needs to match the deterministic model.
S1013: Determine uncertainty parameters, distributions of the uncertainty parameters, and the target parameter.

In the process of BEPU analysis, the uncertainty of input parameters needs to be considered. Therefore, specific uncertainty parameters, as well as their distributions and ranges need to be determined before the analysis. The uncertainty parameters and their distributions are determined mainly based on design data of the nuclear power plant, a phenomena identification and ranking table (PIRT), and empirical judgment. Since each nuclear power plant has its own specificity, there may be bias in the selection of uncertainty parameters. Therefore, initially, a larger number of uncertainty parameters need to be selected for calculation. The target parameter is a key parameter for determining whether the core is damaged under the accident condition. In the case of a small break loss-of-coolant accident, the PCT is the target parameter.
S1014: Perform parameter sensitivity analysis to select key parameters.

A significant number of uncertainty parameters are determined in S1013, which may lead to high dimensionality of the problem, low computational accuracy, and slow convergence in the process of deep learning and optimization algorithm calculation. Therefore, sensitivity analysis needs to be conducted before the analysis to select important uncertainty parameters, reduce the number of input uncertainty parameters, and reduce the difficulty of subsequent analysis.

Further, S1011 of modeling the research object based on deterministic analysis specifically includes the following steps:
S10111: Determine an object and an accident to be analyzed.

Different nuclear power plants have distinct structures and characteristics, requiring specific modeling for each plant. After the modeling object is determined, accidents to be analyzed need to be determined. Different accidents involve different key phenomena and processes, and different systems and equipment have varying modeling accuracy requirements for modeling.
S10112: Obtain all necessary parameter information for a modeling process.

After the research plant and accident are determined, sufficient nuclear power plant parameter information needs to be obtained. By researching design documents, safety analysis reports, and other materials of the nuclear power plant, all parameter information needed for nuclear power plant modeling is determined. For example, the power of the core, structural parameters of the pipes, and the coolant temperature and flow rate at the inlet and outlet of the core.
S10113: Complete an object node diagram based on the key parameters, and write input cards.

Taking the RELAP5 program as an example, the nuclear power plant node diagram is first completed based on the key parameters. The input cards are then written based on this diagram.
S10114: After modeling is completed, compare simulation results with design parameters to ensure that modeling accuracy meets analysis requirements.

In this process, the uncertainty parameters, the ranges and distributions of the uncertainty parameters, and the target parameter are determined based on the deterministic model. On this basis, a multi-threading module and a sampling module of a Python program are used to generate RELAP5 input cards in batches.

Furthermore, S201 specifically includes the following steps:
S2011: Perform initialization for concurrent computing, where input parameters, ranges and distributions of the input parameters, and the target parameter need to be initialized before concurrent computing; and define inputs and outputs for database construction.
S2012: Test performance of computer equipment and complete initialization settings of an optimization program.

During concurrent computing, thread locks need to be set to prevent data of multiple threads from affecting each other. A specific time interval needs to be set to prevent multiple RELAP5 programs, when started, from simultaneously reading a physical property parameter table. Therefore, reaction of the computer performance needs to be tested, and an appropriate delay time needs to be set.
S2013: Update RELAP5 input files in batches by using multiple threads.

Traditional RELAP5 performs serial computing on a computer, which does not fully utilize computing resources and is inefficient. To improve analysis efficiency, in the present disclosure, a Python program is used to develop concurrent computing functions to replace serial computing. Before RELAP5 calculations, new input cards need to be generated in batches using multiple threads. In one process of the computer, n threads are called, and each thread executes parameter sampling, as well as input card modification and update tasks for one input card. When IO_function in Python is called for multi-threaded computing, modification of a global variable will generate multiple duplicate input cards due to data sharing among multiple threads. Therefore, thread locks need to be set between threads to ensure that only the current input card is updated during the data card update process. After the input card update is completed, the new input cards are named using a timestamp plus a thread number to ensure that the input card names are not duplicated.
S2014: Perform multi-threaded RELAP5 calculations.

Only one RELAP5 program can be opened at a time for calculation in one thread. Therefore, a multi-process module in Python is called in combination with the multi-threading module to open one RELAP5 program for calculation in each thread of each process. When starting calculation, the RELAP5 program reads a water property table read. When multiple processes read the same water property table at the same time, an error may occur. Therefore, a small time interval time.sleep( ) is set between each two RELAP5 starts, to ensure that multiple processes do not read the water property table simultaneously.
S2015: Construct input and output databases.

After the RELAP5 calculation is completed, complete o, r files are generated. Since each file name is unique, multiple threads in multiple processes work simultaneously to read the target parameter in the o file. The o, r files generated after the RELAP5 calculation are large. In order to save memory effectively, the o, r files are deleted immediately after each data reading is completed. After completing calculations of all the accident sequences, a database is generated, with input and output parameters in a one-to-one correspondence.

Traditional RELAP5 program can only perform serial computing on a computer. To improve computing efficiency and generate a database for deep learning more efficiently, the present disclosure employs concurrent computing. Taking an 8-core computer with an i7-9700K 3.6 GHz CPU as an example, when performing single-threaded RELAP5 serial computing, the CPU usage rate is about 13%, and it takes about 6 minutes to calculate a single 5000 s case. When 8 processes simultaneously calculate eight 5000 s cases, the CPU usage rate is about 100%, and it takes about 9 minutes. Multi-process concurrent computing can fully utilize CPU computing resources and improve computing efficiency.

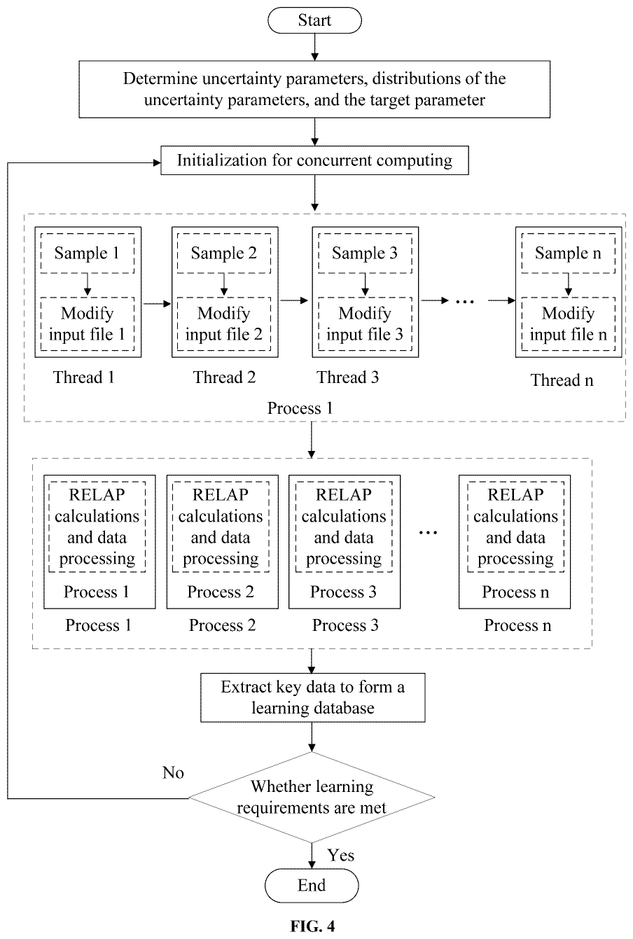

First, based on the deterministic model, the uncertainty parameters, the ranges and distributions of the uncertainty parameters, and the target parameter are determined. On this basis, the multi-threading module and the sampling module of the Python program are used to generate RELAP5 input cards in batches. The multiple-threading module and the multi-process module are used to control concurrent RELAP5 calculations, extract key parameters, and generate a deep learning database. A specific implementation process is shown in FIG. 4.

Furthermore, S301 specifically includes the following steps:
S3011: Construct an FCNN deep learning surrogate model.
S3012: Determine whether an FCNN deep learning surrogate model generated when a current database sample size remains unchanged meets accuracy requirements; if yes, complete model construction and proceed to S401 after encapsulation, to participate in concurrent computing; otherwise, return to S201 to increase the number of learning database samples.

In existing RISMC analyses, system programs are used for accident case analysis, and the single calculation time is long. Taking an 8-core computer with an i7-9700K 3.6 GHz CPU as an example, a single 5000 s case calculation using the RELAP5 program takes about 6 minutes. In the process of finding an optimal solution in the PSO algorithm, multiple particles and multiple generations of calculations are needed to achieve convergence. When there are a large number of calculation cases, the overall calculation time is too long. Additionally, multiple iterations of RELAP5 calculations using the PSO algorithm significantly affect the stability of the program. Therefore, to improve the computing efficiency of single accident analysis case and optimize program stability, a surrogate model needs to be constructed to replace the RELAP5 program for accident analysis. Due to the significant data fluctuations during the accident analysis process, it is difficult to accurately describe the accident process using simple fitting formulas. Therefore, the FCNN approach, which is easy to implement and has strong nonlinear fitting capabilities, is used to construct the surrogate model.

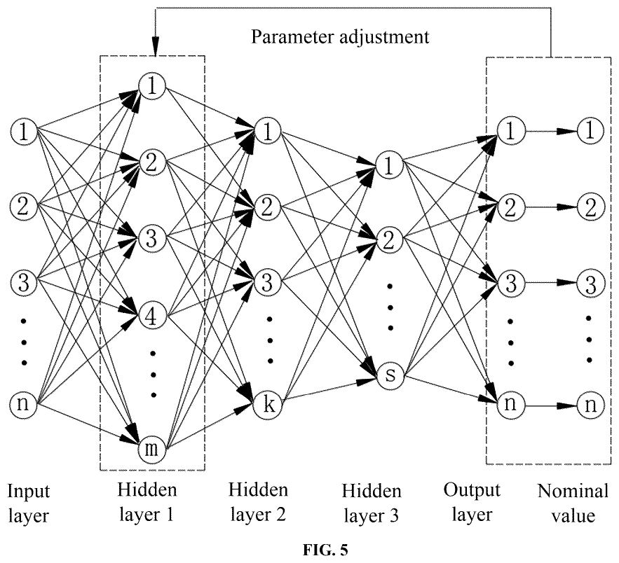

A principle diagram of an FCNN is shown in FIG. 5. The FCNN mainly consists of three parts: an input layer, hidden layers, and an output layer. After the deep learning database of the present disclosure is imported, FCNN input layer information is updated with the input parameter information in the database, and the corresponding output parameters in the database serve as nominal values for fitting accuracy comparison in the output layer. After imported to the input layer, the data is transmitted to the hidden layer. The activation function in the hidden layer ensures that the hidden layer can fit nonlinear data. Output data from hidden layer 1, after fitting, serves as the input for hidden layer 2, and the data is passed successively until it reaches the output layer. The fitted target parameter output from the output layer is compared with the nominal value imported from the database. If an error does not meet the accuracy requirements, the learning rate is automatically adjusted, and the data is fitted again in the hidden layer until the accuracy requirements are met.

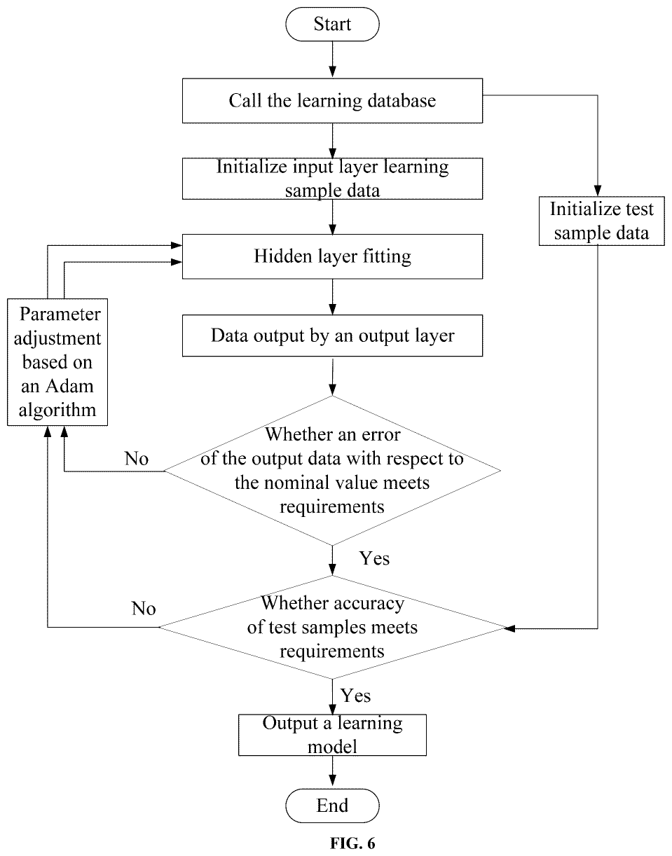

Further, as shown in FIG. 6, S3011 of constructing the FCNN deep learning surrogate model specifically includes the following steps:
S30111: Call a learning database, and import generated database samples to this step for model construction.
S30112: Initialize input layer learning sample data and test sample data, which involves updating nominal values of an input layer and an output layer of an FCNN based on input parameters and output parameters in the database; and initializing activation functions and key information of the FCNN.
S30113: Hidden layer fitting: data from the input layer undergoes nonlinear fitting through an activation function in a hidden layer, and when there are a plurality of hidden layers, an output of a previous hidden layer is passed as an input to a next hidden layer.
S30114: Data output by the output layer: an initial parameter from the input layer yields a fitted target parameter after hidden layer fitting.
S30115: Determine whether an error of fitted output data with respect to a nominal value meets requirements, which involves comparing the fitted target parameter from the output layer with a standard target parameter calculated by the RELAP5 program in the database, and if the error meets a specified value, proceeding to S30116; if the error does not meet the specified value, performing automatic parameter adjustment using an Adam algorithm, proceeding to S30113 until the specified value is met, and then proceeding to S30116.
S30116: Determine whether accuracy of test samples meets specified requirements, which involves importing input data of the test samples into the model and comparing resulting output values with standard output values in the test samples; if the requirements are met, proceeding to a next step; otherwise, continuing with parameter adjustment using the Adam algorithm, until the accuracy meets the specified requirements.

Furthermore, S401 specifically includes the following steps:
S4011: Perform calculations on nominal input values of all accident sequences in S101 using the RELAP5 programs to obtain a nominal target parameter for each sequence.
S4012: Classify the accident sequences and determine target parameter calculation demand of the accident sequences.
S4013: Calculate optimal solutions for the accident sequences using a PSO algorithm.

Further, as shown in FIG. 7, S4013 of calculating the optimal solutions for the accident sequences using the PSO algorithm includes the following steps:
S40131: Initialize particle parameters, which involves setting the number of particles per generation, particle dimensions, total iterations, an inertia weight factor, a learning factor, and key parameters according to the computational requirements, to control a scale and efficiency of PSO optimization.
S40132: Determine input parameters and a target parameter, and complete program initialization settings, which involves updating input parameter information and target parameter information based on a sensitivity analysis result in S101, and performing initialization.
S40133: Call the deep learning surrogate model and perform concurrent computing, which involves calling the deep learning surrogate model encapsulated in S301 to replace RELAP5 for accident analysis calculations.
S40134: Obtain the target parameter and update best fitness values, which involves outputting the target parameter calculated by the deep learning surrogate model, comparing and updating optimal solutions for each generation of the target parameter;
S40135: Determine whether a convergence condition is met, which involves completing program calculations when any convergence condition is met and proceeding to S40136; otherwise, updating initial parameters of each accident analysis sequence based on the PSO algorithm and proceeding to S40133 for iterative calculations.
S40136: Output optimal solution data.
S40137: Output a sequence screening result, which involves outputting serial numbers of accident sequences that require BEPU analysis based on a comparison of the optimal solution data with safety limits and analysis in S40135.

Further, the convergence condition for PSO calculations includes: (1) a maximum number of iterations is reached; (2) in consecutive generations, changes in optimal solutions are within an error range; (3) an outlier occurs in the target parameter, where the outlier means that a relationship between a calculated target parameter of a sequence and the safety limits is different from a relationship between the nominal target parameter of the sequence and the safety limits.

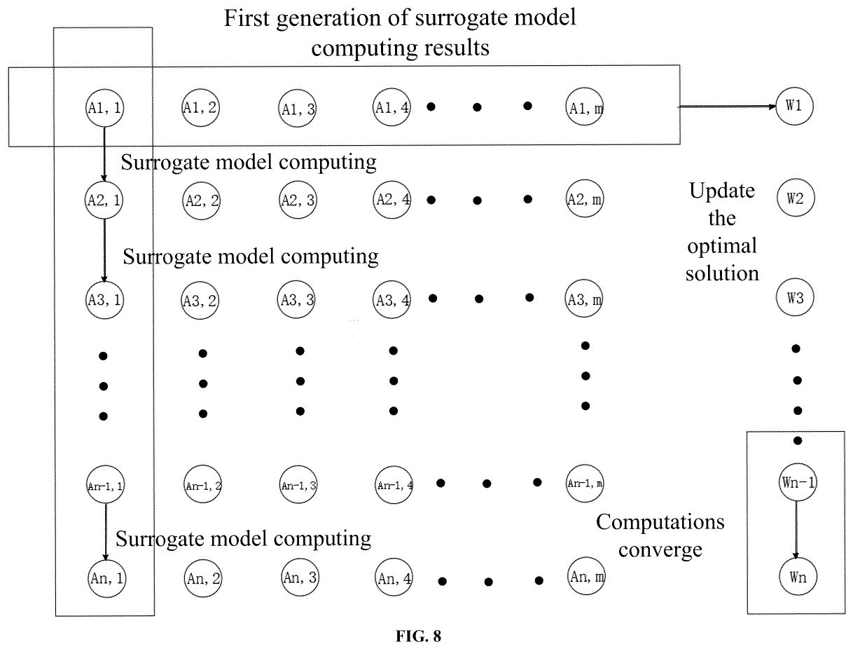

FIG. 8 is a principle diagram of data iterations in a PSO algorithm, where A1,1 represents the first particle of the first generation, while An,m represents the m-th particle of the n-th generation. Solving maximum values of the target parameter for accident sequences is taken as an example. In the present disclosure, each particle represents a target parameter calculated by the surrogate model. First, based on the initialized input parameters, all results of the first generation are calculated, and a maximum value W1 is screened out from all the results. Then, a new set of input parameters are used according to the PSO algorithm, target parameters of the second generation are calculated, and a maximum value W2 is screened out. If W2 is greater than W1, the rightmost optimal solution is updated with W2. If W2 is less than W1, the rightmost optimal solution remains W1. This process continues iteratively, updating the optimal solution generation by generation. When differences of 10 consecutive generations of optimal solutions meet the accuracy requirements, the calculation terminates, and the optimal solution is outputted.

The above description of the disclosed embodiments enables those skilled in the art to achieve or use the present disclosure progressively. Various modifications to these embodiments are readily apparent to those skilled in the art, and the generic principles defined herein may be practiced in other embodiments without departing from the spirit or scope of the present disclosure. Accordingly, the present disclosure will not be limited to these examples shown herein, but is to fall within the widest scope consistent with the principles and novel features disclosed herein.

What is claimed is:

1. An accident sequence screening method based on a combination of a fully connected neural network (FCNN) and particle swarm optimization (PSO), comprising the following steps:
S101: defining a research object and a target parameter, and completing deterministic and probabilistic modeling;
S201: concurrently computing RELAP5 programs by using a concurrent computing method, to quickly construct a deep learning database;
S301: constructing a deep learning surrogate model by using an FNCC analysis method, to replace RELAP5 for accident analysis; and
S401: calling the deep learning surrogate model for accident analysis by using a PSO approach, quickly capturing an optimal solution for each accident sequence, and screening out sequences that require Best Estimate Plus Uncertainty (BEPU) analysis.

2. The accident sequence screening method based on a combination of an FCNN and PSO according to claim 1, wherein
S101 specifically comprises the following steps:
S1011: modeling the research object based on deterministic analysis;
S1012: determining all accident sequences based on a probabilistic model;
S1013: determining uncertainty parameters, distributions of the uncertainty parameters, and the target parameter; and
S1014: performing parameter sensitivity analysis to select key parameters.

3. The accident sequence screening method based on a combination of an FCNN and PSO according to claim 2, wherein
S1011 of modeling the research object based on deterministic analysis specifically comprises the following steps:
S10111: determining an object and an accident to be analyzed;
S10112: obtaining all necessary parameter information for a modeling process;
S10113: completing an object node diagram based on the key parameters, and writing input cards; and
S10114: after modeling is completed, comparing simulation results with design parameters to ensure that modeling accuracy meets analysis requirements.

4. The accident sequence screening method based on a combination of an FCNN and PSO according to claim 1, wherein
S201 specifically comprises the following steps:
S2011: performing initialization for concurrent computing, wherein input parameters, ranges and distributions of the input parameters, and the target parameter are initialized before concurrent computing; and defining inputs and outputs for database construction;
S2012: testing performance of computer equipment and completing initialization settings of an optimization program;
S2013: updating RELAP5 input files in batches by using multiple threads;
S2014: performing multi-threaded RELAP5 calculations; and
S2015: constructing input and output databases.

5. The accident sequence screening method based on a combination of an FCNN and PSO according to claim 1, wherein
S301 specifically comprises the following steps:
S3011: constructing an FCNN deep learning surrogate model; and
S3012: determining whether an FCNN deep learning surrogate model generated when a current database sample size remains unchanged meets accuracy requirements; if yes, completing model construction and proceeding to S401 after encapsulation, to participate in concurrent computing; otherwise, returning to S201 to increase the number of learning database samples.

6. The accident sequence screening method based on a combination of an FCNN and PSO according to claim 5, wherein
S3011 of constructing the FCNN deep learning surrogate model specifically comprises the following steps:
S30111: calling a learning database, and importing generated database samples to the step for model construction;
S30112: initializing input layer learning sample data and test sample data: updating nominal values of an input layer and an output layer of an FCNN based on input parameters and output parameters in the database; and initializing activation functions and key information of the FCNN;
S30113: hidden layer fitting, wherein data from the input layer undergoes nonlinear fitting through the activation function in a hidden layer, and when there are a plurality of hidden layers, an output of a previous hidden layer is passed as an input to a next hidden layer;
S30114: data output by the output layer, wherein an initial parameter from the input layer yields a fitted target parameter after hidden layer fitting;
S30115: determining whether an error of fitted output data with respect to a nominal value meets requirements: comparing the fitted target parameter from the output layer with a standard target parameter calculated by the RELAP5 program in the database, and if the error meets a specified value, proceeding to S30116; if the error does not meet the specified value, performing automatic parameter adjustment using an Adam algorithm, proceeding to S30113 until the specified value is met, and then proceeding to S30116;
S30116: determining whether accuracy of test samples meets specified requirements: importing input data of the test samples into the model and comparing resulting output values with standard output values in the test samples; if the requirements are met, proceeding to a next step; otherwise, continuing with parameter adjustment using the Adam algorithm, until the accuracy meets the specified requirements.

7. The accident sequence screening method based on a combination of an FCNN and PSO according to claim 1, wherein
S401 specifically comprises the following steps:
S4011: performing calculations on nominal input values of all accident sequences in S101 using the RELAP5 programs to obtain a nominal target parameter for each sequence;
S4012: classifying the accident sequences and determining target parameter calculation demand of the accident sequences; and
S4013: calculating optimal solutions for the accident sequences using a POS algorithm.

8. The accident sequence screening method based on a combination of an FCNN and PSO according to claim 7, wherein
S4013 of calculating the optimal solutions for the accident sequences using the POS algorithm specifically comprises the following steps:
S40131: initializing particle parameters: setting the number of particles per generation, particle dimensions, total iterations, an inertia weight factor, a learning factor, and key parameters according to the computational requirements, to control a scale and efficiency of PSO optimization;
S40132: determining input parameters and a target parameter, and completing program initialization settings: updating input parameter information and target parameter information based on a sensitivity analysis result in S101, and performing initialization;
S40133: calling the deep learning surrogate model and performing concurrent computing:
calling the deep learning surrogate model encapsulated in S301 to replace RELAP5 for accident analysis calculations;
S40134: obtaining the target parameter and updating best fitness values: outputting the target parameter calculated by the deep learning surrogate model, comparing and updating optimal solutions for each generation of the target parameter;
S40135: determining whether a convergence condition is met: completing program calculations when any convergence condition is met and proceeding to S40136; otherwise, updating initial parameters of each accident analysis sequence based on the PSO algorithm and proceeding to S40133 for iterative calculations;
S40136: outputting optimal solution data; and
S40137: outputting a sequence screening result: based on a comparison of the optimal solution data with safety limits and analysis in S40135, outputting serial numbers of accident sequences that require BEPU analysis.

9. The accident sequence screening method based on a combination of an FCNN and PSO according to claim 8, wherein
the convergence condition for PSO calculations comprises: (1) a maximum number of iterations is reached; (2) in consecutive generations, changes in optimal solutions are within an error range; (3) an outlier occurs in the target parameter, wherein the outlier means that a relationship between a calculated target parameter of a sequence and the safety limits is different from a relationship between the nominal target parameter of the sequence and the safety limits.
